(19) United States
(12) Patent Application Publication
(10) Pub. No.: US 2013/0284630 A1
(43) Pub. Date: Oct. 31, 2013

(54) CASES FORMED FROM BOOKS

(71) Applicants: Shana Rebecca Siegel, Brooklyn, NY (US); Joshua Brandon Kesner, Brooklyn, NY (US)

(72) Inventors: Shana Rebecca Siegel, Brooklyn, NY (US); Joshua Brandon Kesner, Brooklyn, NY (US)

(21) Appl. No.: 13/459,237

(22) Filed: Apr. 29, 2012

(51) Int. Cl. B65D 85/00; B32B 38/10

(52) U.S. Cl. 206/457; 156/264

(57) ABSTRACT

An effective, physically protective case for small electronic devices is made from repurposed books. The case may conceal the device to make it appear as a less valuable item. The case, being made from old, repurposed books, makes use of items that may otherwise be disposed of, thereby preventing waste. By using an actual book, rather than trying to replicate the look of a book, the case can effectively conceal ebooks, tablet computers, smart phones, and the like, even under the closest inspection. The case is sturdy, has few moving parts, is durable and is produces using only recycled materials.

### BACKGROUND OF THE INVENTION

The present invention relates to electronic device cases and, more particularly, to electronic device cases, such as cases for ebooks or smartphones, made from books.

Ebooks and smartphones often are protected by a physically protective case. These electronic devices are easily identified as valuable items for theft, not only for their monetary value, but also for the personal information stored on these devices.

Conventional electronic device cases are made from new materials, using virgin resources. Those made from natural resources may not be physically appealing.

As can be seen, there is a need for an improved case for an electronic device that may be made from re-purposed old books.

### SUMMARY OF THE INVENTION

In one aspect of the present invention, a case for an electronic device comprises a book repurposed for use as the case, the book having a central region of a plurality of pages removed to form an interior cavity, wherein the interior cavity is adapted to contain the electronic device therewithin.

In another aspect of the present invention, a method for making a case for an electronic device comprises removing a central region from a plurality of pages of a book to form an interior cavity; and laminating pages of a page periphery surrounding the interior cavity.

In a further aspect of the present invention, a case for an electronic device comprises a book repurposed for use as the case, the book having a central region of a plurality of pages removed to form an interior cavity, wherein the interior cavity is adapted to contain the electronic device therewithin; a page periphery surrounding the interior cavity being laminated together; at least one notch formed in the page periphery, the notching communicating the interior cavity with an exterior of the book; and a catch for retaining a front cover of the book over the interior cavity.

These and other features, aspects and advantages of the present invention will become better understood with reference to the following drawings, description and claims.

### BRIEF DESCRIPTION OF THE DRAWINGS

FIG. 1 is a perspective view of a case according to an exemplary embodiment of the present invention;

FIG. 2 is a perspective view of the case of FIG. 1, in an opened configuration; and

FIG. 3 is an exploded view of the case of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an effective physically protective case for small electronic devices made from repurposed books. The case of the present invention may conceal the device to make it appear as a less valuable item. The case, being made from old, repurposed books, makes use of items that may otherwise be disposed of, thereby preventing waste. By using an actual book, rather than trying to replicate the look of a book, the case of the present invention can effectively conceal ebooks, tablet computers, smart phones, and the like, even under the closest inspection. The case is sturdy, has few moving parts, is durable and is produces using only recycled materials.

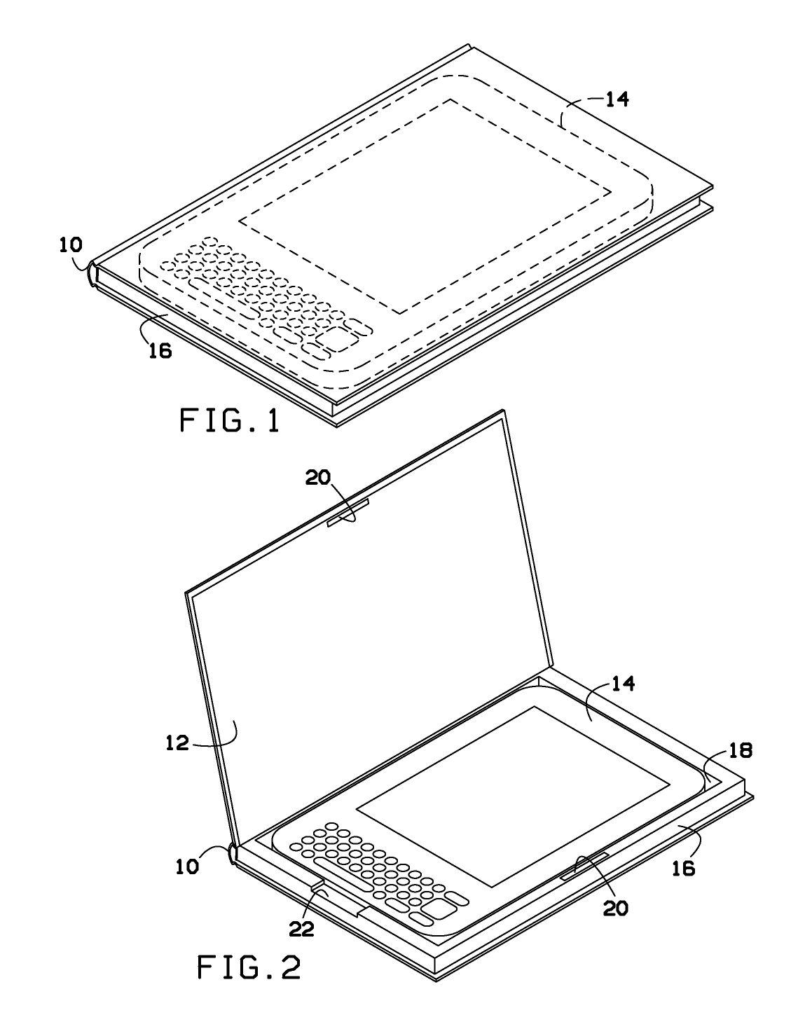

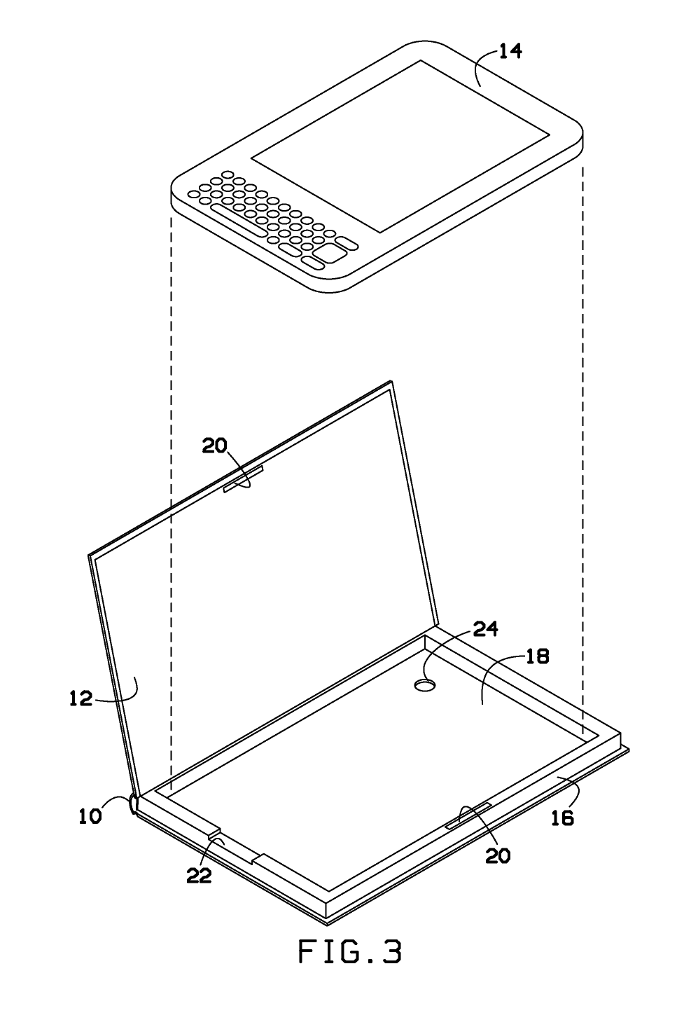

Referring now to FIGS. 1 through 3, a book 10 may be repurposed into a case for an electronic device 14, such as a ebook, tablet computer, smart phone, or the like.

Inside the book 10, an interior cavity 18 may be formed by cutting a central region from a stack of pages. The remaining page periphery 16 may be, for example, laminated or glued together to help define the interior cavity 18.

A front cover 12 of the book 10 may be lifted to reveal the interior cavity 18. In some embodiments, one or more pages of the book 10, immediately inside the front cover 12, may remain intact. For example, a title page of the book 10 may remain intact to provide a level of authenticity to the experience of the case being a book. In addition, depending on the desired thickness of the interior cavity 18, one or more pages near a back cover of the book can remain intact. In other words, the number of pages cut out to form the interior cavity 18 may vary depending on the desired thickness of the interior cavity 18.

A notch 22 may be cut along one or more edges of the book 10. The notch 22 may create a path between the interior cavity 18 and the outside of the book 10. The notch 22 may provide access to the device 14, even when the book 10 is closed. This may be convenient, for example, to providing a charging cable to the device 14. The notch 22 may also provide an access point to help a user remove the device 14 from the interior cavity 18.

A catch 20 may be provided in the front cover and along the page periphery 16 to help retain the cover 12 in a closed position. The catch 20 may be, for example, a magnetic catch.

It should be understood, of course, that the foregoing relates to exemplary embodiments of the invention and that modifications may be made without departing from the spirit and scope of the invention as set forth in the following claims.

What is claimed is:

1. A case for an electronic device comprising:
a book repurposed for use as the case, the book having a central region of a plurality of pages removed to form an interior cavity, wherein the interior cavity is adapted to contain the electronic device therewithin.

2. The case of claim 1, further comprising a page periphery surrounding the interior cavity being laminated together.

3. The case of claim 2, further comprising at least one notch formed in the page periphery, the notching communicating the interior cavity with an exterior of the book.

4. The case of claim 1, further comprising a catch for retaining a front cover of the book over the interior cavity.

5. The case of claim 4, wherein the catch is a magnetic catch.

6. A method for making a case for an electronic device, the method comprising:
removing a central region from a plurality of pages of a book to form an interior cavity; and
laminating pages of a page periphery surrounding the interior cavity.

7. The method of claim 6, wherein the plurality of pages includes sufficient pages to create an interior cavity having a thickness at least as thick as the electronic device.

8. The method of claim 6, further comprising closing a front cover of the book over the interior cavity and retaining the front cover in a closed position with a catch.

9. The method of claim 6, further comprising cutting a notch along the page periphery, the notch communicating the interior cavity with an exterior of the book.

10. A case for an electronic device comprising:
a book repurposed for use as the case, the book having a central region of a plurality of pages removed to form an interior cavity, wherein the interior cavity is adapted to contain the electronic device therewithin;
a page periphery surrounding the interior cavity being laminated together;
at least one notch formed in the page periphery, the notching communicating the interior cavity with an exterior of the book; and
a catch for retaining a front cover of the book over the interior cavity.
